(19) United States
(12) Patent Application Publication
(10) Pub. No.: US 2011/0153674 A1
(43) Pub. Date: Jun. 23, 2011

(54) DATA STORAGE INCLUDING STORING OF PAGE IDENTITY AND LOGICAL RELATIONSHIPS BETWEEN PAGES

(75) Inventors: Jeffrey A. East, Redmond, WA (US); Ryan L. Stonecipher, Camation, WA (US); Emily N. Wilson, Seattle, WA (US); Kevin G. Farlee, Maple Valley, WA (US); Ankur Kemkar, Mercer Island, WA (US)

(73) Assignee: Microsoft Corporation, Redmond, WA (US)

(21) Appl. No.: 12/641,715

(22) Filed: Dec. 18, 2009

(51) Int. Cl. G06F 17/30; G06F 7/00; G06F 12/10

(52) U.S. Cl. 707/797; 711/209; 707/812; 707/E17.044; 711/E12.001; 711/E12.059

(57) ABSTRACT

Methods, systems, and computer-readable media of data storage that include storing page identities of individual pages and logical relationships between pages are disclosed. A particular system includes a plurality of data storage devices. A storage manager is configured to store data as pages at the data storage devices. Each page includes a page payload and a page identity. The storage manager is also configured to store one or more relationships indicating logical order between pages.

### BACKGROUND

Physical storage of database files (e.g., tables) typically includes dividing the database files into fixed-size fragments and storing the individual fragments to disk. When a database file is retrieved by a database application, multiple fragments of the database file are individually retrieved and combined in memory. Database applications typically expect (e.g., based on offsets) that if a first portion of the database file logically precedes a second portion of the database file, then the first portion of the database file will be located physically prior (e.g., have a lower memory address or offset) to the second portion of the database file on the disk. As database files become more fragmented, reordering the fixed-size fragments or logical objects therein to meet this expectation may become time-consuming (e.g., due to swapping data and modifying offsets) and may slow down overall performance at the database.

### SUMMARY

A database storage methodology that decouples physical storage from logical ordering is disclosed. Database files are stored as pages, where each page may have a unique identity. A logical ordering of the pages may be stored separately from the pages. Thus, the logical ordering of the pages is independent of physical storage location, and a physical ordering of the pages and may be modified without modifying the logical ordering of the pages or data payloads of the individual pages. For example, page ordering may be modified based on access patterns such as a frequency of access and a likelihood of sequential access vs. random access. Such page reordering may be performed without impacting a database application or other software that accesses the database.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram to illustrate a particular embodiment of a system of data storage that includes storing page identities and logical relationships between pages;

FIG. 2 is a block diagram to illustrate a particular embodiment of the page sequence of FIG. 1;

FIG. 3 is a diagram to illustrate a particular embodiment of a method of reordering pages;

FIG. 4 is a diagram to illustrate a particular embodiment of a data storage hierarchy at a computer system that includes stored page identities and logical relationships between pages;

FIG. 5 is a flow diagram to illustrate a particular embodiment of a method of data storage that includes storing page identity and logical relationships between pages;

FIG. 6 is a flow diagram to illustrate another particular embodiment of a method of data storage that includes storing page identity and logical relationships between pages; and

FIG. 7 is a block diagram of a computing environment including a computing device operable to support embodiments of computer-implemented methods, computer program products, and system components as illustrated in FIGS. 1-6.

### DETAILED DESCRIPTION

Systems, methods, and computer-readable media of data storage are disclosed. Data (e.g., database files) are stored as page sequences at data storage devices, where each page sequence includes multiple pages. Page sequences are individually retrievable by name and each page of a page sequence is individually retrievable by a page identity that is stored with the page. A logical ordering (e.g., predecessor and successor relationships) of the pages is also stored. Thus, page sequences may be moved across data storage devices and individual pages within a sequence may be rearranged (e.g., based on observed access patterns). For example, two non-adjacent pages that are commonly accessed together may be moved so that they are contiguous.

In a particular embodiment, a system includes a plurality of data storage devices and a storage manager. The storage manager is configured to store data as one or more pages. Each page includes a page payload and a page identity. The storage manager is also configured to store one or more relationships that indicate a logical order between each particular page and one or more other pages.

In another particular embodiment, a method includes storing a first page of a data file that is stored as a plurality of pages. Each particular page of the data file includes a page payload and a page identity. The method also includes storing a second page of the data file. The second page is a logical successor of the first page but initially not a physical successor of the first page. The method further includes modifying a physical location of one or more of the first page and the second page to place the second page physically adjacent to the first page. It should be noted that page ordering may be governed by multiple factors. In a particular embodiment, page ordering may be determined solely based on logical relationships. In another particular embodiment, page ordering may be determined solely based on data access patterns or based on a combination of logical relationships and data access patterns. In yet another embodiment, page ordering may be determined based on application logic independent of both data access patterns and logical relationships.

In another particular embodiment, a computer-readable medium is disclosed. The computer-readable medium includes instructions, that when executed by a computer, cause the computer to store a database file of a database as a plurality of pages. The plurality of pages includes a first page that is a physical and logical predecessor of a second page and a third page that is a physical and logical successor of the second page. The instructions also cause the computer to determine that an access pattern of the database indicates that a combined access of the first page and the third page occurs more frequently than a combined access of the first page and the second page. The instructions further cause the computer to reorder the plurality of pages based on the access pattern. After the reordering, the third page is a physical successor of the first page and is the physical predecessor of the second page.

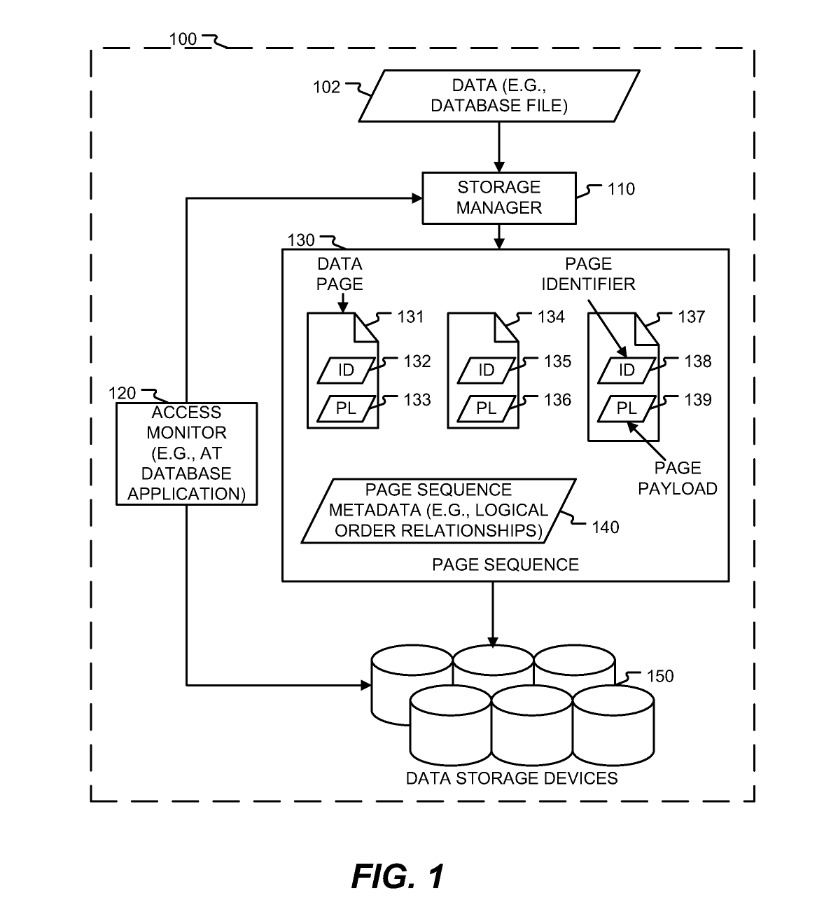

FIG. 1 is a diagram to illustrate a particular embodiment of a system 100 of data storage that includes storing page identities and logical relationships between pages. The system 100 includes a storage manager 110 and a plurality of data storage devices 150. The system 100 may also include an access monitor 120 (e.g., integrated into a database application) to observe data access patterns associated with data retrieved from and stored at the data storage devices 150. For example, the system 100 may be part of a database server, a kernel-mode database driver, or a user-mode database library at a computer system.

The storage manager 110 is configured to store data 102 (e.g., a database file) as one or more pages at the data storage devices 150. For example, the pages may represent a binary-plus-tree (B+-tree) storage scheme of a database, a heap-based storage scheme of a database, or some other storage scheme. The pages may be fixed-size (e.g., 8 kb) or may be of varying size. In a particular embodiment, one or more pages (e.g., the data pages 131, 134, 137) are stored as a page sequence (e.g., the page sequence 130). Page sequences may be fixed-size or may be of varying size. Each particular data page in the page sequence includes a page identity and a page payload. For example, the first data page 131 includes the first page identity 132 and the first page payload 133. The second data page 134 includes the second page identity 135 and the second page payload 136, and the third data page 137 includes the third page identity 138 and the third page payload 139. In a particular embodiment, the page identities 132, 135, 138 enable the storage manager 110 to individually retrieve the data pages 131, 134, 137, respectively.

The storage manager 110 is also configured to store one or more relationships that indicate a logical order between pages. For example, the storage manager 110 may store logical relationships of the data pages 131, 134, 137 as page sequence metadata 140 of the page sequence 130. The page sequence metadata 140 may be stored along with or separately from each of the data pages 131, 134, 137, as illustrated in FIG. 1. In a particular embodiment, each of the data pages 131, 134, 137 has one or more of a logical predecessor relationship with a logically preceding page and a logical successor relationship with a logically succeeding page. It should be noted that logical relationships may be different from physical relationships. For example, the page sequence metadata 140 may indicate that two data pages that are stored contiguously in memory are not logically related to each other. Thus, the physical order of the data pages 131, 134, 137 may be modified without modifying the logical order of the pages (e.g., as indicated by the page sequence metadata 140).

In a particular embodiment, the system 100 includes an access monitor 120 configured to monitor transactions occurring at a database having data stored at the data storage devices 150. For example, the access monitor 120 may determine a data access pattern associated with the database based on an observation of database access characteristics, such as random access, sequential access, an average number of pages per access, a frequency of access, or any combination thereof. In a particular embodiment, access pattern information associated with a page sequence (e.g., the page sequence 130) or pages thereof (e.g., the data pages 131, 134, 137) is stored as metadata of the page sequence (e.g., the page sequence metadata 140).

The data storage devices 150 may include non-volatile memory such as hard disks. In a particular embodiment, the data storage devices 150 include one or more redundant array of inexpensive disks (RAID) arrays. In a particular embodiment, the data storage devices 150 perform sequential access faster than non-sequential access (e.g., random access). It may thus be advantageous to relocate logically related pages so that they are contiguous (e.g., accessible via sequential access). It may also be advantageous to relocate pages that are frequently accessed or commonly accessed together (e.g., as determined by the access monitor 120) so that they are contiguous.

Thus, a set of pages may have three associated orderings: a logical ordering (e.g., in what order the pages are combined to form a database object), a physical ordering (e.g., in what order the pages are physically stored on disk), and an access pattern ordering (e.g., in what order the pages are commonly accessed). In a particular embodiment, the storage manager 110 may strive to keep the three orders identical. When the three orders are not identical (e.g., due to fragmentation of database files residing at an operating system, fragmentation of data objects within the database files, or a combination thereof), the storage 110 may physically relocate pages so that the physical order matches the logical order. Alternately, the storage manager 110 may determine the physical ordering based on access patterns. For example, as a database becomes older and access patterns are observed for a longer period of time, the access patterns may be weighted to have a higher influence on physical ordering and the logical ordering may be weighted to have a lower influence on physical ordering.

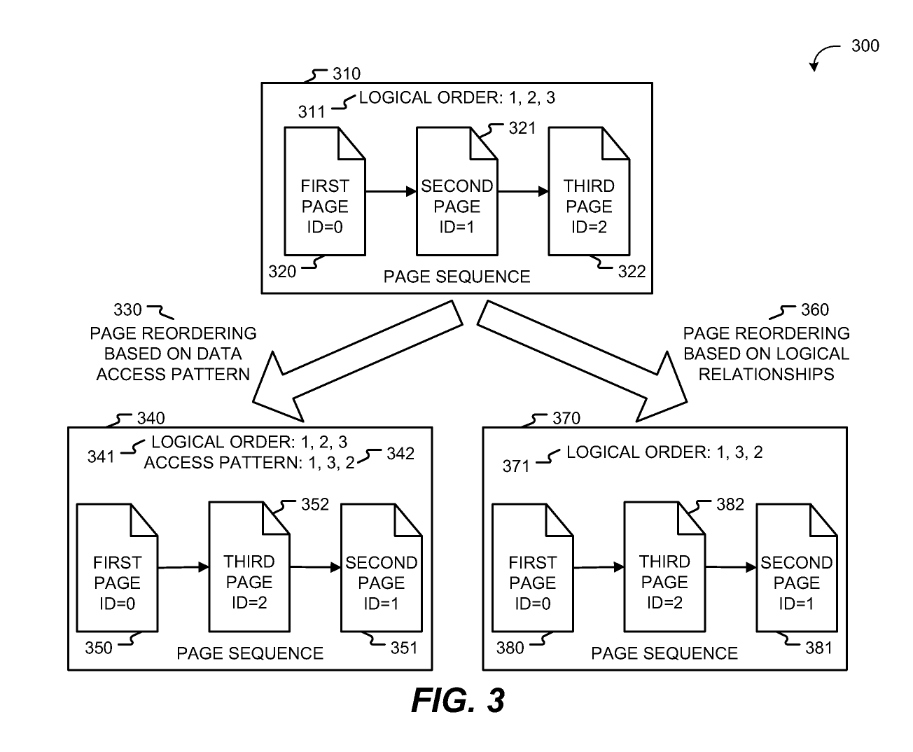

In a particular embodiment, the storage manager 110 is configured to relocate data pages based on access patterns, including modifying the page sequence metadata 140 to reflect reordered data pages. For example, when the data storage devices 150 store pages of a database as a B+-tree, B+-tree operations may be performed by the storage manager 110. During operation, the B+-tree may become increasingly fragmented. That is, logically related pages of the B+-tree may be less likely to be located contiguously, and reading a particular file of the database may require multiple random accesses. For example, a node split operation may occur with respect to two physically and logically contiguous nodes A and B, such that following the split, a newly allocated node C logically exists between A and B but physically exists far (e.g., at a different data storage device) from A and B. Subsequent to the node split operation (e.g., during an idle time of the database), one or more of the nodes A, B, and C may be physically moved to restore the benefits of sequential access. Because pages may be retrieved by page identity, physical reordering of pages may be performed without modification or duplication of page payloads or of previously existing database applications or queries. In a particular embodiment, an execution thread of the storage manager 110 may continuously examine data access patterns and reorder pages to improve data access performance at a database. In another particular embodiment, page reordering may be triggered by a database administrator. An exemplary page reordering operation is further described with reference to FIG. 3.

In operation at FIG. 1, the storage manager 110 may store the data 102 to and retrieve the data 102 from the data storage devices 150. The data 102 may be stored as the data pages 131, 134, 137 of the page sequence 130, and the page sequence metadata 140 may indicate a logical order of the data pages 131, 134, 137. For example, each of the data pages 131, 134, 137 may have zero, one, or two logical order relationships (e.g., a predecessor relationship, a successor relationship, or both).

The access monitor 120 may monitor database transactions associated with the page sequence 130 to determine one or more access patterns associated with the data pages 131, 134, 137 of the page sequence 130. The storage manager 110 may reorder (e.g., physical reordering) the data pages 131, 134, 137 based on the access patterns. It should be noted that page relationships other than “predecessor” and “successor” may be used. For example, a nested table implementation may include “contains” relationships, which may be used to keep child pages close to parent pages.

It will be appreciated that the system 100 of FIG. 1 may decouple physical storage (e.g., at the data storage devices 150) from logical ordering by storing relationship metadata separately from pages. Thus, the physical ordering of pages may be updated (e.g., based on data access patterns) to improve data access performance without changing or copying of page payloads or page identities and without impacting the logical ordering of the pages.

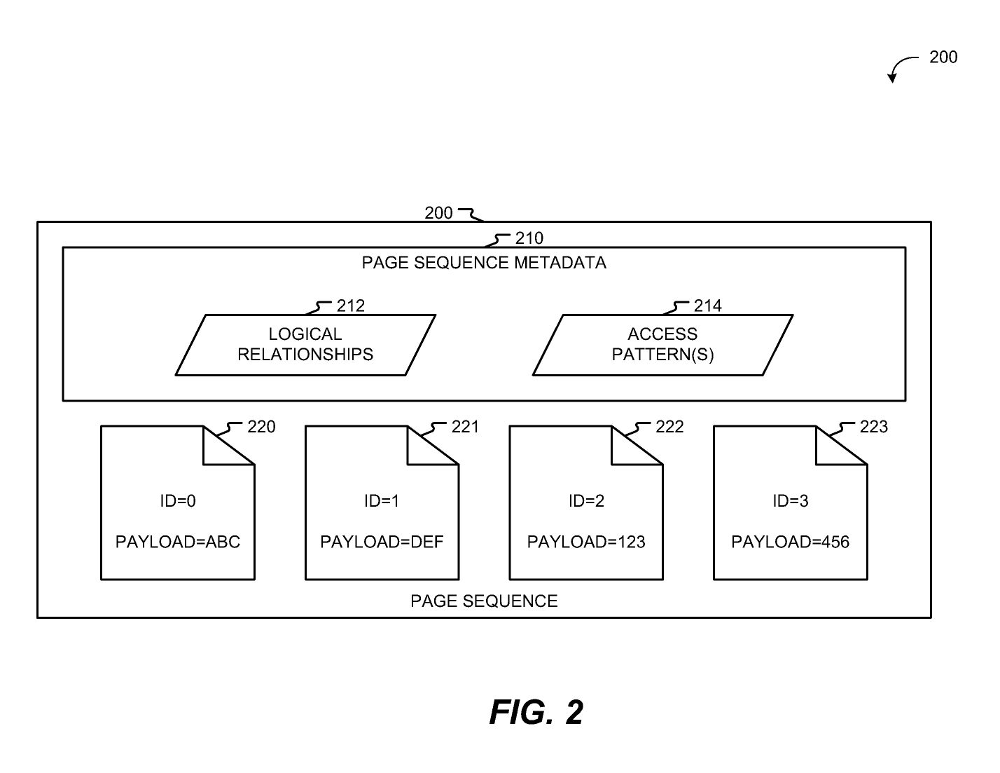

FIG. 2 is a block diagram to illustrate a particular embodiment of a page sequence 200. In an illustrative embodiment, the page sequence 200 is the page sequence 130 of FIG. 1.

Page sequences, such as the page sequence 200 of FIG. 2, may include one or more data pages. For example, the page sequence 200 includes four data pages 220, 221, 222, and 223. Each page may include a page identity (e.g., a unique 64-bit identifier) and a page payload. For example, the first page 220 has an identity “0” and a payload “ABC.” The second page 221 has an identity “1” and a payload “DEF.” The third page 222 has an identity “2” and a payload “123.” The fourth page 223 has an identity “3” and a payload “456.”

Page sequences may also include metadata associated with the page sequence and individual pages of the page sequence. For example, the page sequence 200 of FIG. 2 includes page sequence metadata 210. In an illustrative embodiment, the page sequence metadata 210 is the page sequence metadata 140 of FIG. 1. The page sequence metadata 210 may include or identify logical relationships 212 between the pages 220-223 of the page sequence. For example, the logical relationships 212 may indicate that a logical order of the pages 220-223, by page identity, is “0, 1, 2, 3.” The logical relationships 212 may indicate that the first page 220 may be a logical predecessor of the second page 221, the second page 221 may be a logical predecessor of the third page 222, and the third page 222 may be a logical predecessor of the fourth page 223. Similarly, the logical relationships 212 may indicate that the second page 221 may be a logical successor of the first page 220, the third page 222 may be a logical successor of the second page 221, and the fourth page 223 may be a logical successor of the third page 222.

The page sequence metadata 210 may also include access patterns 214 associated with the page sequence 200. For example, the access patterns 214 may indicate whether the pages 220-223 are more often involved in sequential data access or random data access. As another example, the access patterns 214 may indicate an average number of pages of the page sequence 200 accessed during a data access (e.g., read or write) operation and how often pages of the page sequence 200 are accessed. It should be noted that although the access patterns 214 are illustrated in FIG. 2 as stored within the page sequence metadata 210, the access patterns 214 may instead be stored separately from, and have a different lifespan than, the page sequence metadata 210. In an illustrative embodiment, the access patterns 214 are observed and reported by a database access monitor, such as the access monitor 120 of FIG. 1.

It will be appreciated that the page sequence 200 of FIG. 2 may conveniently encapsulate logical relationships 212, access patterns 214, and individual pages 220-223. Thus, pages of a page sequence may be reordered without retrieving any other data. It will further be appreciated that because access patterns may be defined at a page sequence level, access patterns may be associated with multiple pages in a page sequence. For example, a particular access pattern may be common to the pages 220-222 and the page 223 may be individually associated with a different access pattern.

FIG. 3 is a diagram to illustrate a particular embodiment of a method 300 of reordering pages. In a particular embodiment, a data storage system (e.g., the system 100 of FIG. 1) may logically and physically reorder pages based on an access pattern, such that the logical and physical ordering of the reordered pages remains identical. Maintaining identical logical and physical ordering of pages may increase a likelihood that multiple pages of a database file are accessed sequentially.

A page sequence 310 may include a plurality of pages, such as the pages 320, 321 and 322. Each page may have a unique page identity. For example, the pages 320, 321, and 322 have the identities “0,” “1,” and “2,” respectively. A logical order 311 “1, 2, 3” and a physical order 312 “1, 2, 3” may be associated with the pages 320-322, where the logical order 311 indicates the order in which the pages 320-322 form a database file and the physical order 312 indicates the order in which the pages 320-322 are stored at physical media (e.g., as stored at data storage devices).

In a particular embodiment, the page sequence 310 may be subjected to a page reordering operation 330 based on data access patterns. The page reordering operation 330 may be performed in response to an observed data access pattern associated with the page sequence 310. For example, it may be determined that a combined access of the first page 320 and the third page 322 occurs more frequently than a combined access of the second page 321 and the third page 322. Thus, modifying the page sequence 310 to relocate the third page 322 adjacent to the first page 320 may result in a performance improvement due to an increased likelihood of sequential data access at the page sequence 310.

Following such a page reordering operation 330 based on data access patterns, the page sequence 310 may be arranged as illustrated by the page sequence 340 of FIG. 3. In the page sequence 340, although the logical order 341 remains “1, 2, 3,” the third page 352 is located between the first page 350 and the second page 351. An access pattern 342 “1, 3, 2” indicates that the pages 350-352 of the page sequence 340 are commonly accessed in the order “1, 3, 2.” Thus, physical ordering and access ordering may be modified without modification of logical ordering.

Alternately, the page sequence 310 may be subjected to a page reordering operation 360 based on logical relationships. For example, the logical relationships of the page sequence 310 may change (e.g., due to an action by a database administrator or due to a B+-tree splitting operation) such that the third page 322 becomes logically located between the first page 320 and the second page 321. The physical ordering of the page sequence 310 may be modified to reflect the updated logical order. Following such a page reordering operation 360 based on logical relationships, the page sequence 310 may be arranged as illustrated by the page sequence 370 of FIG. 3. In the page sequence 370, the third page 382 is located between the first page 380 and the second page 381. The logical order 371 indicates that the logical ordering of the page sequence 370 has changed to “1, 3, 2.” Thus, physical ordering and logical ordering may be modified without modification of access ordering.

It should be noted that logical and physical reordering may be achieved in various ways. In a particular embodiment, reordering may occur without modifying page payloads. For example, a set of relationship pointers that indicate a logical order may be modified without modifying the underlying payloads of the pages referred to by the pointers. In another particular embodiment, reordering may involve copying or swapping payloads of various pages. It should also be noted that although the particular embodiment illustrated in FIG. 3 depicts both logical and physical reordering, one of logical and physical reordering may instead occur without the other.

It will be appreciated that the method 300 of FIG. 3 may enable one of logical and physical reordering of pages in a page sequence without impacting the other. With certain page reordering, the method 300 of FIG. 3 may increase a likelihood of sequential page access and decrease a likelihood of random page access, thereby providing a performance improvement at a database.

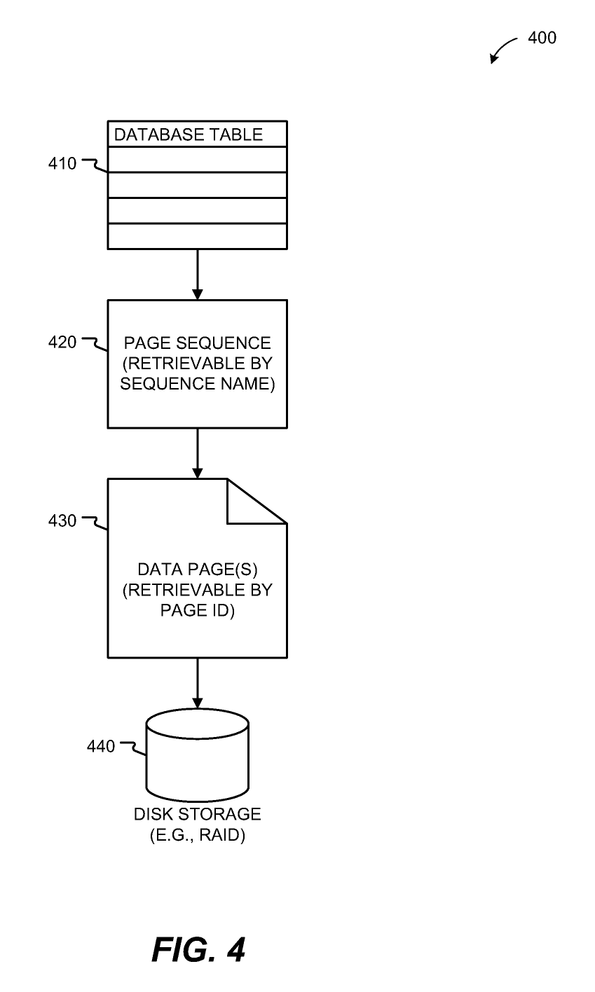

FIG. 4 is a diagram to illustrate a particular embodiment of a data storage hierarchy 400 at a computer system that includes stored page identities and logical relationships between pages. In an illustrative embodiment, the data storage hierarchy 400 may be implemented by the system 100 of FIG. 1.

The data storage hierarchy 400 may generally be considered a top-down hierarchy arranged in decreasing level of abstraction. For example, a top level of the hierarchy may include one or more database tables, such as an illustrative database table 410. Database tables may be of any size and may include any number of rows and columns of data. In a particular embodiment, the database table 410 may be referred to via a single table name. The table name may be used without regard to the underlying storage scheme of the data. For example, even though the entire database table 402 may be referred to by a single table name, the database table 402 may be stored in multiple nodes of one or more B+-trees or a heap-based structure.

In a particular embodiment, data of the database table 410 is stored in one or more page sequences, such as an illustrative page sequence 420. The page sequence 420 may be retrievable by a page sequence name. The page sequence 420 may include a plurality of data pages, such as an illustrative data page 430. The data page 430 may be individually retrievable by a page identity.

A bottom level of the data storage hierarchy may include physical storage, such as illustrative disk storage 440. The disk storage 440 may include one or more data storage devices that are part of a RAID array. The disk storage 440 may also be direct-attached, on a storage area network (SAN), or network-attached.

It will be appreciated that the data storage hierarchy 400 of FIG. 4 may provide multiple levels of abstraction. For example, page sequence names may decouple page sequences from the physical media used to store the page sequences, and page identities may decouple the payload of pages from the relative (e.g., logical) order of the pages within the page sequence. It will thus be appreciated that the data storage hierarchy 400 of FIG. 4 may simplify the creation and use of database management applications. It will further be appreciated that the data storage hierarchy 400 of FIG. 4 may enable database data to be moved from one data storage device to another storage device, including a remote data storage device, without impacting database design. For example, a database application may successfully retrieve a particular payload from a particular page using a particular page identity regardless of how many times the logical relationships and the physical location of the particular page has been changed.

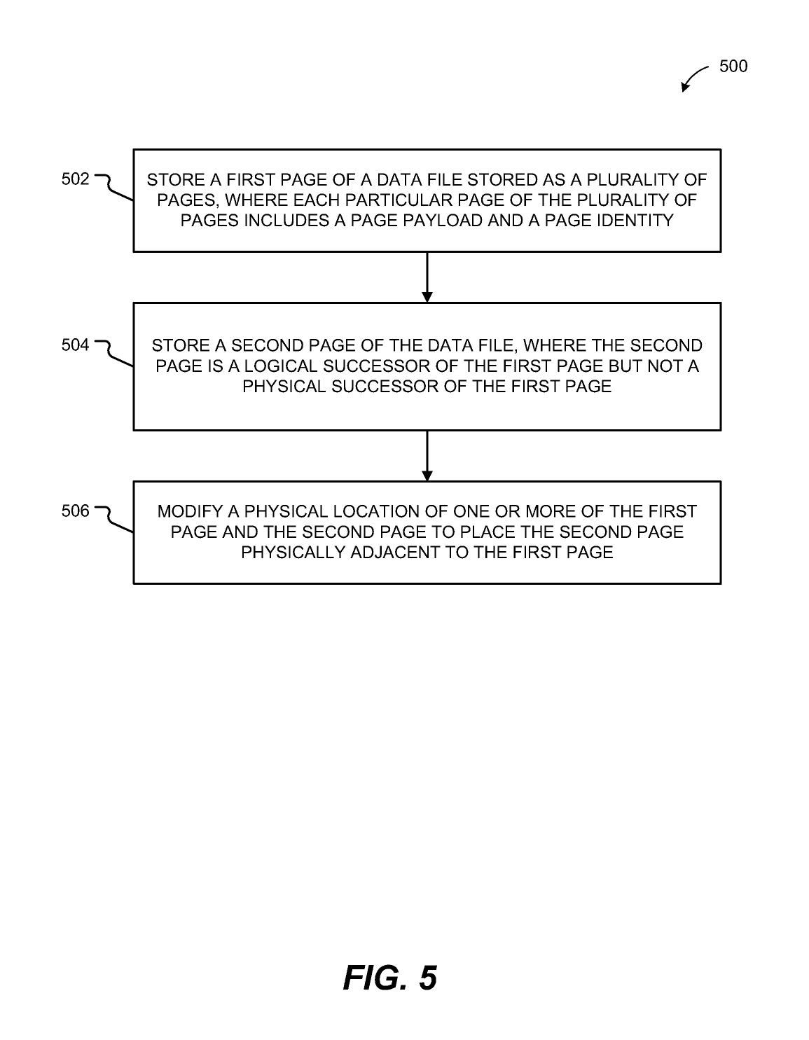

FIG. 5 is a flow diagram to illustrate a particular embodiment of a method 500 of data storage that includes storing page identities of pages and logical relationships between pages. In an illustrative embodiment, the method may be performed by the system 100 of FIG. 1 and illustrated by the page reordering operation 360 of FIG. 3.

The method 500 includes storing a first page of a data file, at 502. The data file is stored as a plurality of pages, and each particular page includes a page payload and a page identity. For example, in FIG. 3, the first page 320 may be stored.

The method 500 also includes storing a second page of the data file, at 504. The second page is a logical successor of the first page but not a physical successor of the first page. For example, in FIG. 3, the third page 322 may be stored, and the logical ordering of the page sequence 310 may change to “1, 3, 2,” as illustrated by the logical order 371.

The method 500 further includes modifying a physical location of one or more of the first page and the second page to place the second page physically adjacent to the first page, at 506. For example, in FIG. 3, the pages may be physically reordered as illustrated by the page reordering operation 360, after which the first page 380 and the third page 382 are physically adjacent. In a particular embodiment, the physical location of one or more of the pages is modified during an idle time of the database.

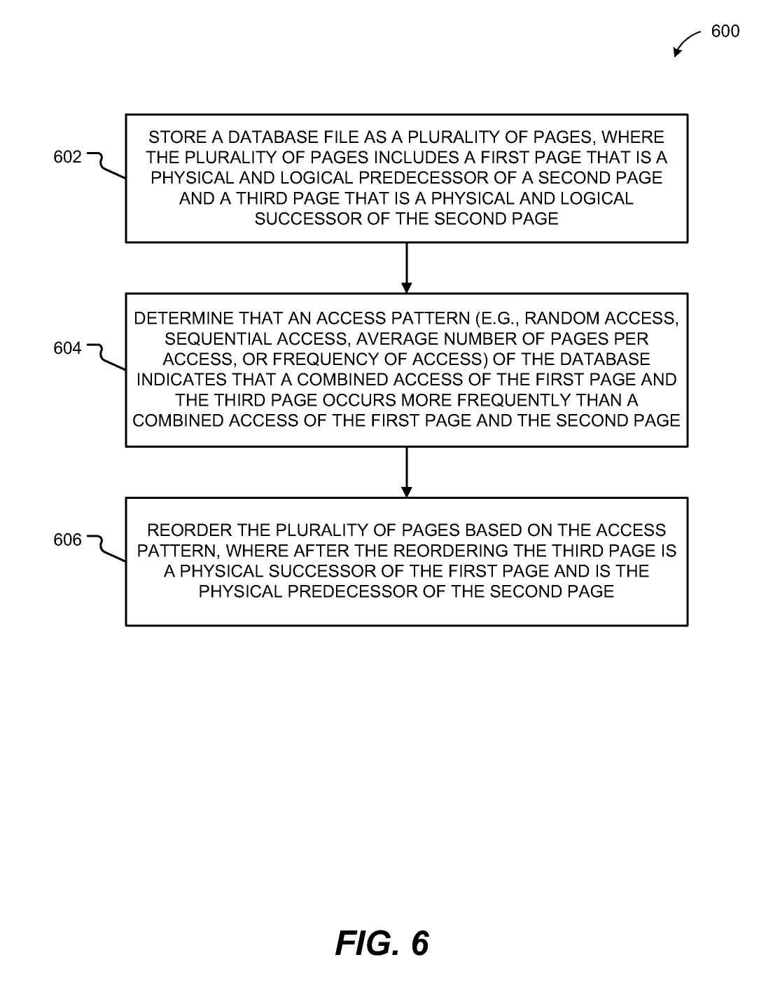

FIG. 6 is a flow diagram to illustrate another particular embodiment of a method 600 of data storage that includes storing page identity information and logical relationships between pages. In an illustrative embodiment, the method 600 may be performed by the system 100 of FIG. 1 and illustrated by the page reordering operation 330 of FIG. 3.

The method 600 includes storing a database file as a plurality of pages, at 602. The pages include a first page that is a physical and logical predecessor of a second page. The pages also include a third page that is a physical and logical successor of the second page. For example, referring to FIG. 3, a database file may be stored as the pages 320-322 of the page sequence 310. The second page 321 is a logical and physical successor of the first page 320 and the third page 322 is a logical and physical successor of the second page 321.

The method 600 also includes determining that an access pattern of the database indicates that a combined access of the first page and the third page occurs more frequently than a combined access of the first page and the second page, at 604. For example, it may be determined that previously completed database queries resulted in reading data from both the first page and the third page more often than reading data from both the first page and the second page. As another example, it may be determined that database update operations resulted in writing data to both the first page and the third page more often than writing data to both the first page and the second page. For example, referring to FIG. 3, it may be determined that a combined access of the first page 320 and the third page 322 occurs more frequently than a combined access of the first page 320 and the second page 321.

The method 600 further includes reordering the plurality of pages based on the access pattern, at 606. After the reordering, the third page is a physical successor of the first page and the third page is the physical predecessor of the second page. For example, referring to FIG. 3, the pages may be reordered as illustrated by the pages 350-352, where the third page 352 is the physical successor of the first page 350 and the third page 352 is the physical predecessor of the second page 351. After the reordering, the first page 350 and the third page 351 may be retrieved using a sequential data access operation instead of two random data access operations.

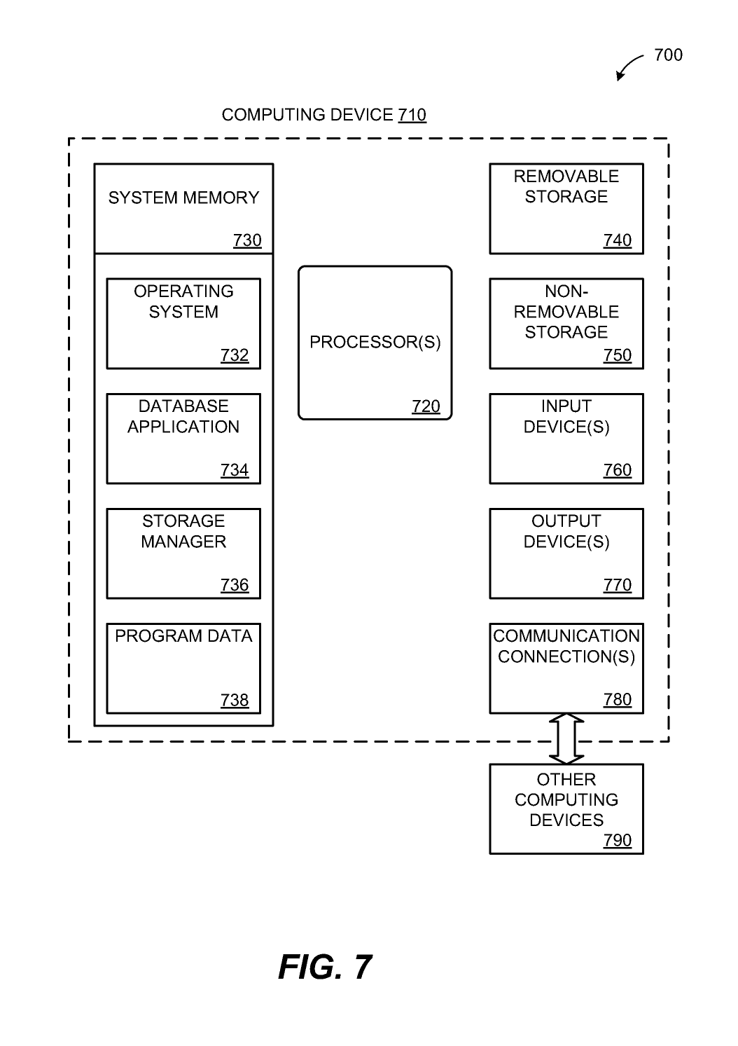

FIG. 7 depicts a block diagram of a computing environment 700 including a computing device 710 operable to support embodiments of computer-implemented methods, computer program products, and system components according to the present disclosure. In an illustrative embodiment, the computing device 710 may include one or more of the storage manager 110, the access monitor 120, and the data storage devices 150 of FIG. 1. Each of the storage manager 110, the access monitor 120, and the data storage devices 150 of FIG. 1 may include or be implemented using the computing device 710 or a portion thereof.

The computing device 710 includes at least one processor 720 and a system memory 730. Depending on the configuration and type of computing device, the system memory 730 may be volatile (such as random access memory or “RAM”), non-volatile (such as read-only memory or “ROM,” flash memory, and similar memory devices that maintain stored data even when power is not provided), or some combination of the two. The system memory 730 typically includes an operating system 732, one or more application platforms, one or more applications (e.g., a database application 734 and a storage manager 736), and program data 738 associated with the one or more applications. In an illustrative embodiment, the database application 734 includes the access monitor 120 of FIG. 1. In an illustrative embodiment, the storage manager 736 is the storage manager 110 of FIG. 1. It should be noted that in particular embodiments, the storage manager 736 may be incorporated into the database application 734.

The computing device 710 may also have additional features or functionality. For example, the computing device 710 may also include removable and/or non-removable additional data storage devices such as magnetic disks, optical disks, tape, and standard-sized or flash memory cards. Such additional storage is illustrated in FIG. 7 by removable storage 740 and non-removable storage 750. In an illustrative embodiment, one or both of the removable storage 740 and the non-removable storage 750 include the data storage devices 150 of FIG. 1. Computer storage media may include volatile and/or non-volatile storage and removable and/or non-removable media implemented in any technology for storage of information such as computer-readable instructions, data structures, program components or other data. The system memory 730, the removable storage 740 and the non-removable storage 750 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage, other magnetic storage device, solid state non-volatile memory (e.g., solid state drive (SSD) memory), memristor memory, phase-change memory, or any other medium that can be used to store information and that can be accessed by the computing device 710. Any such computer storage media may be part of the computing device 710.

The computing device 710 may also have input device(s) 760, such as a keyboard, mouse, pen, voice input device, touch input device, etc. Output device(s) 770, such as a display, speakers, printer, etc. may also be included. The computing device 710 also contains one or more communication connections 780 that allow the computing device 710 to communicate with other computing devices 790 over a wired or a wireless network.

It will be appreciated that not all of the components or devices illustrated in FIG. 7 or otherwise described in the previous paragraphs are necessary to support embodiments as herein described. For example, the input device(s) 760 and output device(s) 770 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system, comprising:
a plurality of data storage devices; and
a storage manager configured to:
store data as one or more pages at the plurality of data storage devices, wherein each particular page comprises a page payload and a page identity; and
store one or more relationships that indicate a logical order between the particular page and one or more other pages.

2. The system of claim 1, wherein the one or more relationships include a logical predecessor relationship between the particular page and a logically preceding page of the particular page, a logical successor relationship between the particular page and a logically succeeding page of the particular page, or any combination thereof.

3. The system of claim 1, wherein the plurality of pages is stored as a page sequence and wherein the one or more relationships are stored as page sequence metadata of the page sequence, where the metadata of the page sequence is stored separately from each of the plurality of pages.

4. The system of claim 3, wherein the storage manager is further configured to modify a physical order of the plurality of pages at the plurality of data storage devices without modifying a logical order of the plurality of pages.

5. The system of claim 4, wherein the physical order of the plurality of pages is modified based on one or more access patterns associated with a database.

6. The system of claim 5, wherein the one or more access patterns include random access, sequential access, an average number of pages per access, a frequency of access, or any combination thereof.

7. The system of claim 5, further comprising a database access monitor configured to determine the one or more access patterns based on transactions occurring at the database.

8. The system of claim 5, wherein access patterns associated with the page sequence are stored at the page sequence metadata.

9. The system of claim 1, wherein the particular page is individually retrievable by the storage manager based on the page identity of the particular page.

10. The system of claim 1, wherein the storage manager is incorporated into a database server.

11. The system of claim 1, wherein the storage manager is incorporated into a kernel-mode database driver of a computer system.

12. The system of claim 1, wherein the storage manager is incorporated into a user-mode database library of a computer system.

13. The system of claim 1, wherein the plurality of pages represent one of a binary-plus-tree (B+-tree) storage scheme of a database and a heap-based storage scheme of a database.

14. The system of claim 1, wherein the page identity comprises a 64-bit identifier.

15. A method, comprising:
storing a first page of a data file of a database stored as a plurality of pages, wherein each particular page of the plurality of pages comprises a page payload and a page identity;
storing a second page of the data file, wherein the second page is a logical successor of the first page but not a physical successor of the first page; and
modifying a physical location of one or more of the first page and the second page to place the second page physically adjacent to the first page.

16. The method of claim 15, wherein the first page and the second page are stored at a page sequence of the plurality of pages, the page sequence uniquely retrievable via a name of the page sequence.

17. The method of claim 15, further comprising reading data of the data file from the first page and from the second page.

18. The method of claim 15, further comprising writing data of the data file to the first page and to the second page.

19. A computer-readable medium comprising instructions, that when executed by a computer, cause the computer to:
store a database file of a database as a plurality of pages, wherein the plurality of pages includes a first page that is a physical and logical predecessor of a second page and a third page that is a physical and logical successor of the second page;
determine that an access pattern of the database indicates that a combined access of the first page and the third page occurs more frequently than a combined access of the first page and the second page; and
reorder the plurality of pages based on the access pattern, wherein after the reordering the third page is a physical successor of the first page and is the physical predecessor of the second page.

20. The computer-readable medium of claim 19, wherein each of the plurality of pages comprises a page payload and wherein the reordering does not modify the page payload of any of the plurality of pages.
